(19) United States
(12) Patent Application Publication
(10) Pub. No.: US 2026/0105572 A1
(43) Pub. Date: Apr. 16, 2026

(54) FEATURE MAP PROCESSING METHOD AND APPARATUS AND COMPUTER READABLE STORAGE MEDIUM

(71) Applicant: CHINA TELECOM CORPORATION LIMITED, Beijing (CN)

(72) Inventors: Huifen WANG, BEIJING (CN); Junda XUE, BEIJING (CN); Yuan ZHANG, BEIJING (CN); Mingchuan YANG, BEIJING (CN); Minrui SHI, BEIJING (CN)

(21) Appl. No.: 19/116,164

(22) PCT Filed: Aug. 24, 2023
(86) PCT No.: PCT/CN2023/114674

§ 371 Date: Mar. 27, 2025

(30) Foreign Application Priority Data
Sep. 29, 2022 (CN) 202211198854.6

(51) Int. Cl. G06T 5/20; G06V 10/771

(52) U.S. Cl. CPC G06T 5/20; G06V 10/771

(57) ABSTRACT

The present disclosure relates to a feature map processing method and apparatus, and a computer-readable storage medium, and relates to the field of image processing. The feature map processing method includes: determining a position of an anchor of a first convolutional kernel in a feature map at a next moment, according to a position of the anchor of the first convolutional kernel in the feature map at a current moment; determining a position of an anchor of at least one second convolutional kernel in the feature map at the next moment, according to a position that the anchor of the first convolutional kernel has already passed; and performing convolution on the feature map region corresponding to the first convolutional kernel by the first convolutional kernel and performing convolution on the feature map region corresponding to the at least one second convolutional kernel by the at least one second convolutional kernel simultaneously, at the next moment.

### CROSS-REFERENCE TO RELATED APPLICATIONS

The present disclosure a U.S. National Stage Application under 35 U.S.C. § 371 of International Patent Application No. PCT/CN2023/114674, filed on Aug. 24, 2023, which is based on and claims the priority to the Chinese application No. 202211198854.6 filed on Sep. 29, 2022, the disclosure of both of which are hereby incorporated by reference in entirety.

### TECHNICAL FIELD

The present disclosure relates to the field of image processing, and in particular, to a feature map processing method and apparatus, and a computer-readable storage medium.

### BACKGROUND

Thanks to the advances in artificial intelligence and computing power, computer vision technology has made great strides towards integration into people's daily lives. The application of deep learning in computer image information processing can not only greatly improve the computer's information expression and knowledge generalization capabilities for acquiring and characterizing images, but also make more convenient, efficient, fast, accurate and effective computer image analysis and processing.

In the image processing, deep learning-based end-to-end coding has been greatly developed. In some advanced end-to-end artificial intelligence coding (e.g., chessboard context model, 3D context model, etc.) methods, a convolution context model is often adopted for a feature map extracted from an image, to improve coding performance.

### SUMMARY

According to a first aspect of the present disclosure, there is provided a feature map processing method, comprising: determining a position of an anchor of a first convolutional kernel in a feature map at a next moment, according to a position of the anchor of the first convolutional kernel in the feature map at a current moment; determining a position of an anchor of at least one second convolutional kernel in the feature map at the next moment, according to a position that the anchor of the first convolutional kernel has already passed; and performing convolution on the feature map region corresponding to the first convolutional kernel by the first convolutional kernel and performing convolution on the feature map region corresponding to the at least one second convolutional kernel by the at least one second convolutional kernel simultaneously, at the next moment.

In some embodiments, the determining a position of an anchor of at least one second convolutional kernel in the feature map at the next moment, according to a position that the anchor of the first convolutional kernel has already passed, comprises: determining the position of the anchor of the at least one second convolutional kernel in the feature map at the next moment, according to the position that the anchor of the first convolutional kernel has already passed and a position that the anchor of the second convolutional kernel has already passed.

In some embodiments, the determining the position of the anchor of the at least one second convolutional kernel in the feature map at the next moment, according to the position that the anchor of the first convolutional kernel has already passed and a position that the anchor of the second convolutional kernel has already passed, comprises: determining, according to the position that the anchor of the first convolutional kernel has already passed and the position that the anchor of the second convolutional kernel has already passed, at least one pair of feature points which are a first feature point located in an opposite direction of a first direction of the position of the anchor of the second convolutional kernel in the feature map at the next moment and a second feature point located in an opposite direction of a second direction thereof, wherein the first direction is a movement direction of the anchor of the first convolutional kernel in a row direction, and the second direction is a movement direction of the anchor of the first convolutional kernel in a column direction; and determining the position of the anchor of the second convolutional kernel in the feature map at the next moment according to the at least one pair of feature points.

In some embodiments, the determining the position of the anchor of the second convolutional kernel in the feature map at the next moment according to the at least one pair of feature points, comprises: for each pair of feature points in the at least one pair of feature points, determining a position of an anchor of one second convolutional kernel in the feature map at the next moment, according to a position located in the first direction of the first feature point and in the second direction of the second feature point.

In some embodiments, the determining a position of an anchor of a first convolutional kernel in a feature map at a next moment, according to a position of the anchor of the first convolutional kernel in the feature map at a current moment, comprises: when the first convolutional kernel does not reach an edge of the feature map in the first direction at the current moment, determining the position of the anchor of the first convolutional kernel in the feature map at the next moment, according to a position of the anchor of the first convolutional kernel after moving by a first stride in the first direction.

In some embodiments, the determining a position of an anchor of a first convolutional kernel in a feature map at a next moment, according to a position of the anchor of the first convolutional kernel in the feature map at a current moment, comprises: when the first convolutional kernel reaches an edge of the feature map in the first direction at the current moment, determining the position of the anchor of the first convolutional kernel in the feature map at the next moment, according to the position of the anchor of the first convolutional kernel in the feature map at the current moment and a padding parameter of the convolution.

In some embodiments, the when the first convolutional kernel reaches an edge of the feature map in the first direction at the current moment, determining the position of the anchor of the first convolutional kernel in the feature map at the next moment, according to the position of the anchor of the first convolutional kernel in the feature map at the current moment and a padding parameter of the convolution, comprises: determining the position of the anchor of the first convolutional kernel in the feature map at the next moment, according to a position that the anchor of the first convolutional kernel reaches after moving by a second stride in the second direction and moving by a same length as the padding parameter in the opposite direction of the first direction, from the position in the feature map at the current moment.

In some embodiments, the position that the anchor of the first convolutional kernel has already passed comprises the position of the anchor of the first convolutional kernel in the feature map at the current moment, and the determining a position of an anchor of at least one second convolutional kernel in the feature map at the next moment, according to a position that the anchor of the first convolutional kernel has already passed, comprises: determining one or more values of an offset parameter according to the position of the anchor of the first convolutional kernel in the feature map at the current moment, wherein each of the values of the offset parameter corresponds to one second convolutional kernel; for the value of each offset parameter, determining a row index of a position of an anchor of the corresponding second convolutional kernel in the feature map at the next moment, according to the value of the offset parameter and a row index of the position of the anchor of the first convolutional kernel in the feature map at the current moment; and for the value of each offset parameter, determining a column index of the position of the anchor of the corresponding second convolutional kernel in the feature map at the next moment, according to the value of the offset parameter and a column index of the position of the anchor of the first convolutional kernel in the feature map at the current moment.

In some embodiments, the determining one or more values of an offset parameter according to the position of the anchor of the first convolutional kernel in the feature map at the current moment, comprises: generating a plurality of candidate values of the offset parameter, wherein the plurality of candidate values are an arithmetic progression; for each candidate value, determining whether the candidate value, the padding parameter and the column index of the position of the anchor of the first convolutional kernel in the feature map at the current moment satisfy a preset inequality; and determining the one or more values of the offset parameter according to one or more candidate values that satisfy the preset inequality.

In some embodiments, the determining the value of the offset parameter according to a candidate value that satisfies the preset inequality, comprises: when the first convolutional kernel reaches an edge of the feature map in the first direction at the current moment, determining the one or more values of the offset parameter according to a candidate value that satisfies the preset inequality and is not 1, wherein the first direction is a movement direction of the anchor of the first convolutional kernel in the row direction.

In some embodiments, the column index of the position of the anchor of the second convolutional kernel in the feature map at the next moment is in a negative correlation with the padding parameter of the convolution.

In some embodiments, the row index of the position of the anchor of the second convolutional kernel in the feature map at the next moment is in positive correlation with the offset parameter and in positive correlation with the row index of the position of the anchor of the first convolutional kernel in the feature map at the current moment.

In some embodiments, the column index of the position of the anchor of the second convolutional kernel in the feature map at the next moment is in negative correlation with the offset parameter and in positive correlation with the column index of the position of the anchor of the first convolutional kernel in the feature map at the current moment.

In some embodiments, the padding parameter of the convolution is in positive correlation with a size of the first convolutional kernel.

In some embodiments, performing convolution on the feature map region corresponding to the first convolutional kernel by the first convolutional kernel and performing convolution on the feature map region corresponding to the at least one second convolutional kernel by the at least one second convolutional kernel simultaneously, at the next moment, comprises: determining the feature map region corresponding to the first convolutional kernel according to the position of the anchor of the first convolutional kernel in the feature map at the next moment; and determining the feature map region corresponding to the second convolutional kernel according to the position of the anchor of the second convolutional kernel in the feature map at the next moment.

In some embodiments, the position of the anchor of the first convolutional kernel in the feature map at the next moment and the position of the anchor of the second convolutional kernel in the feature map at the next moment are in different rows.

According to a second aspect of the present disclosure, there is provided a feature map processing apparatus, comprising: a first determination module configured to determine a position of an anchor of a first convolutional kernel in a feature map at a next moment, according to a position of the anchor of the first convolutional kernel in the feature map at a current moment; a second determination module configured to determine a position of an anchor of at least one second convolutional kernel in the feature map at the next moment, according to a position that the anchor of the first convolutional kernel has already passed; and a convolution module configured to, perform convolution on the feature map region corresponding to the first convolutional kernel by the first convolutional kernel and perform convolution on the feature map region corresponding to the at least one second convolutional kernel by the at least one second convolutional kernel simultaneously, at the next moment.

According to a third aspect of the present disclosure, there is provided a communication device, comprising: a memory; and a processor coupled to the memory, the processor being configured to perform, based on instructions stored in the memory, the feature map processing method according to some embodiments of the present disclosure.

According to a fourth aspect of the present disclosure, there is provided a computer-readable storage medium having thereon stored computer program instructions which, when executed by a processor, implement the feature map processing method according to some embodiments of the present disclosure.

### BRIEF DESCRIPTION OF THE DRAWINGS

The accompanying drawings, which constitute a part of this specification, illustrate embodiments of the present disclosure and together with the description, serve to explain the principles of the present disclosure.

The present disclosure may be more clearly understood according to the following detailed description with reference to the accompanying drawings, in which:

FIG. 1 illustrates a schematic diagram of movement of an anchor of a convolutional kernel of context convolution in the related art;

FIG. 2 illustrates a schematic diagram of a convolution sequence of a context convolution in the related art;

FIG. 3 illustrates a flow diagram of a feature map processing method according to some embodiments of the present disclosure;

FIG. 4 illustrates a schematic diagram of movement of an anchor of a first convolutional kernel according to some embodiments of the present disclosure;

FIG. 5 illustrates a schematic diagram of a convolution sequence according to some embodiments of the present disclosure;

FIG. 6 illustrates a block diagram of a feature map processing apparatus according to some embodiments of the present disclosure;

FIG. 7 illustrates a block diagram of a feature map processing apparatus according to other embodiments of the present disclosure;

FIG. 8 illustrates a block diagram of a computer system for implementing some embodiments of the present disclosure.

### DETAILED DESCRIPTION

Various exemplary embodiments of the present disclosure will now be described in detail with reference to the accompanying drawings. It should be noted that: relative arrangements of parts and steps, numerical expressions and numerical values set forth in these embodiments do not limit the scope of the present disclosure unless specifically stated otherwise.

Meanwhile, it should be understood that sizes of the parts shown in the drawings are not drawn to actual scale for the convenience of description.

The following description of at least one exemplary embodiment is merely illustrative in nature and is in no way intended to limit this disclosure and its application or uses.

Techniques, methods, and devices known to one of ordinary skill in the related art may not be discussed in detail but should be regarded as part of the description where appropriate.

In all examples shown and discussed herein, any specific value should be construed as exemplary only and not as limiting. Thus, other examples of the exemplary embodiment may have different values.

It should be noted that: similar reference numbers and letters refer to similar items in the following drawings, and thus, once a certain item is defined in one drawing, it need not be discussed further in subsequent drawings.

In the related art, convolution context brings beneficial effects on improvement in overall performance of an image processing system, but meanwhile, updating calculation based on the convolution context also brings great time complexity to the system. In a context model based on a convolutional neural network, in calculation of a feature point, there is a need for updated feature content located on upper and left sides of the feature point, and thus feature points in a feature channel are calculated row by row and point by point in series, with high time complexity and slow convolution speed, reducing image processing efficiency.

This patent provides a feature map processing method, capable of improving image processing efficiency.

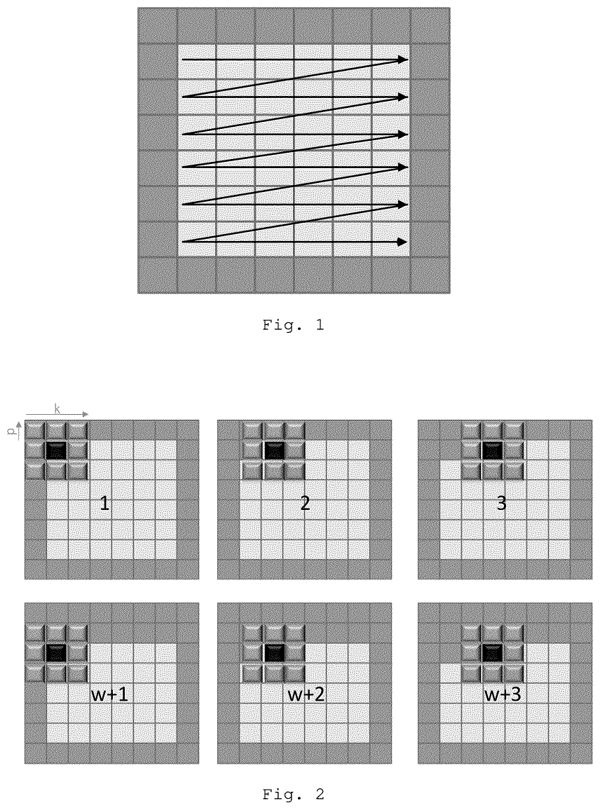

FIG. 1 illustrates a schematic diagram of movement of an anchor of a convolutional kernel of context convolution in the related art.

As shown in FIG. 1, the dark gray edges are points in a feature map to be padded according to padding parameters, and are not taken as positions of anchors of the convolutional kernel. During convolution, the anchor of the convolutional kernel must move step by step from a leftmost side of the feature map to a rightmost side of the current row, then in a new row, move to a leftmost side of a second row, and so on, until the anchor passes all to-be-updated points.

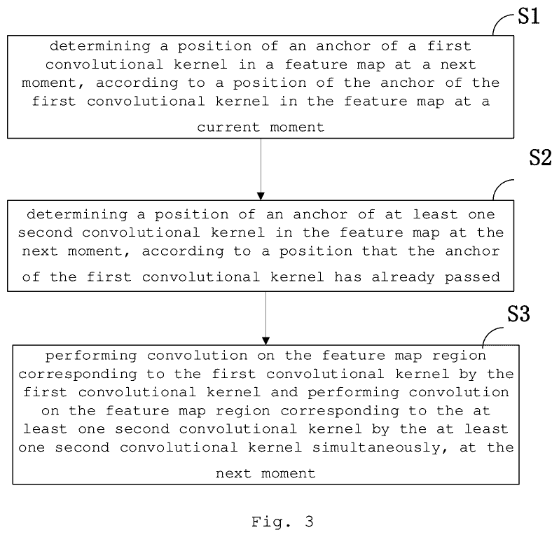

FIG. 2 illustrates a schematic diagram of a convolution sequence of context convolution in the related art.

The number in FIG. 2 is used for representing a moment, wherein at a moment 1, an anchor of a convolutional kernel is at a first position of a first row for convolution. The context convolution differs from normal convolution in that, the context convolution requires that in the convolution, points on left and upper sides of a reference point (where the anchor of the convolutional kernel is located) and within a range of the convolutional kernel, have all already been updated. Therefore, it is required that, after having updated all positions of the first row by the anchor of the convolutional kernel, at a moment w+1, the anchor of the convolutional kernel comes to a first position on a left side of a second row for convolution, where w is a width (excluding a padding edge) of the feature map.

In the related art, in this context convolution row by row and point by point in series, it is required to wait for the positions of the first row having all been updated before the second row can be updated, so that the convolution is inefficient and takes a long time.

FIG. 3 illustrates a flow diagram of a feature map processing method according to some embodiments of the present disclosure.

As shown in FIG. 3, the feature map processing method comprises steps S1 to S3.

Step S1, determining a position of an anchor of a first convolutional kernel in a feature map at a next moment, according to a position of the anchor of the first convolutional kernel in the feature map at a current moment.

For example, for a feature map extracted from an image, a position where an anchor of a first convolutional kernel is located is first taken as a reference point, and the reference point moves in the feature map from the current position to a next position. The anchor of the convolutional kernel is a central point of the convolutional kernel.

In some embodiments, the determining a position of an anchor of a first convolutional kernel in a feature map at a next moment, according to a position of the anchor of the first convolutional kernel in the feature map at a current moment, comprises: when the first convolutional kernel does not reach an edge of the feature map in a first direction at the current moment, determining the position of the anchor of the first convolutional kernel in the feature map at the next moment, according to a position of the anchor of the first convolutional kernel after moving by a first stride in the first direction.

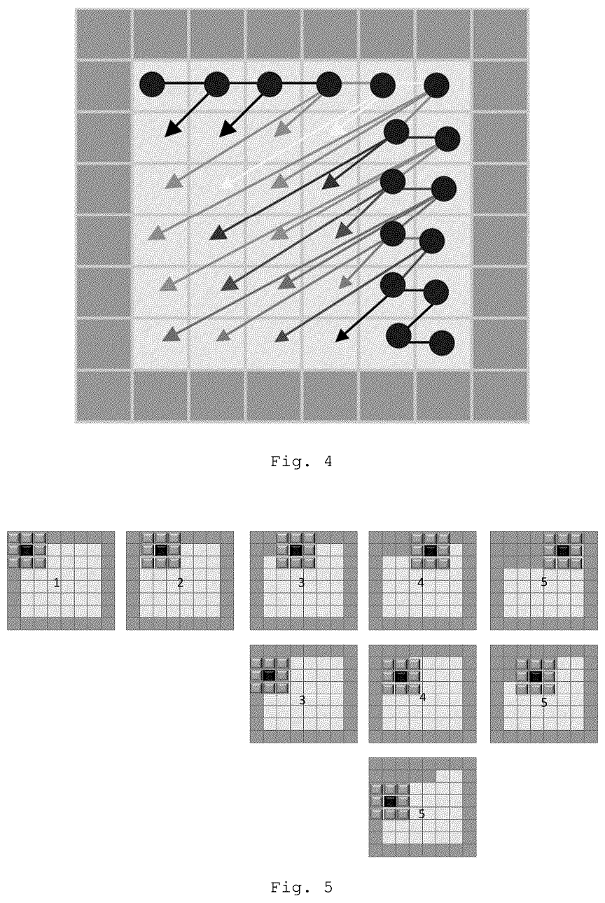

FIG. 4 illustrates a schematic diagram of movement of an anchor of a first convolutional kernel according to some embodiments of the present disclosure.

A position where a circle in FIG. 4 is located represents a position where the first convolutional kernel is located. As shown in FIG. 4, let the first stride be 1 and a size of the first convolutional kernel be 3*3, and the first direction may be a direction of the movement of the first convolutional kernel in a row direction. At a first moment, the anchor (reference point) of the first convolutional kernel is at a first circle in a first row, at a second moment, the reference point moves rightwards to a second circle in the first row, and so on, until the anchor of the first convolutional kernel reaches a last circle in the first row.

For example, if a current position of the anchor of the first convolutional kernel has a coordinate of X₁ (i, j), before it moves, it is first determined whether the following condition is satisfied:

$$j = W - 1$$

where i is a row index, j is a column index, and W is a width of a feature map.

When j=W−1, it is indicated that the convolutional kernel has already reached an image edge, and flag=1 is recorded; and when j=W−1 is not satisfied, flag=0.

When flag=0, the anchor of the first convolutional kernel at the next moment has a position of X₁ (i, j+1), i.e., moving by one pixel rightwards.

In some embodiments, the determining a position of an anchor of a first convolutional kernel in a feature map at a next moment, according to a position of the anchor of the first convolutional kernel in the feature map at a current moment, comprises: when the first convolutional kernel reaches an edge of the feature map in a first direction at the current moment, determining the position of the anchor of the first convolutional kernel in the feature map at the next moment, according to the position of the anchor of the first convolutional kernel in the feature map at the current moment and a padding parameter of the convolution.

As shown in FIG. 4, if the size of the first convolutional kernel is 3*3, when the anchor of the first convolutional kernel reaches a penult circle in FIG. 4, the first convolutional kernel has already reached a rightmost edge of the feature map, or a right edge of the first convolutional kernel coincides with the right edge of the feature map at this moment, flag=1. Then, at this moment, for the anchor of the first convolutional kernel, there is a need to determine the number of points by which it moves leftwards according to the padding parameter, in addition to the need for a new row.

In some embodiments, the when the first convolutional kernel reaches an edge of the feature map in the first direction at the current moment, determining the position of the anchor of the first convolutional kernel in the feature map at the next moment, according to the position of the anchor of the first convolutional kernel in the feature map at the current moment and a padding parameter of the convolution, comprises: determining the position of the anchor of the first convolutional kernel in the feature map at the next moment, according to a position that the anchor of the first convolutional kernel reaches after moving by a second stride in a second direction and moving by a same length as the padding parameter in an opposite direction of the first direction, from the position in the feature map at the current moment.

For example, the second stride is also 1, and the second direction is a direction in which the anchor of the first convolutional kernel moves in a column direction. When a current flag=1, at the next moment, the anchor of the first convolutional kernel moves to X₁ (i+1, j−p), where p is the padding parameter of the convolution.

In some embodiments, the padding parameter of the convolution is in positive correlation with the size of the first convolutional kernel.

For example, the size k of the first convolutional kernel and the padding parameter p satisfy the following formula:

$$p = ( k - 1 ) / 2$$

Step S2, determining a position of an anchor of at least one second convolutional kernel in the feature map at the next moment, according to a position that the anchor of the first convolutional kernel has already passed.

For example, the position that the anchor of the first convolutional kernel has already passed is a point that has already been updated by using the convolutional kernel, and according to the already updated point, it is determined which points can be updated in parallel by using the second convolutional kernel at the next moment. A parameter such as a size of the second convolutional kernel may be the same as that of the first convolutional kernel. The first convolutional kernel differs from the second convolutional kernel only in that, at a same time, the two perform convolution for different positions of an image. The first convolutional kernel and the second convolutional kernel are not limited to a two-dimensional size, but may be in a more dimensional size, such as intra-frame multi-feature-channel simultaneous calculation, inter-frame multi-feature-channel simultaneous calculation.

In the context convolution method according to some embodiments of the present disclosure, for those feature points, which are located on different feature rows and determined to satisfy a convolution updating condition according to the already updated points, updating calculation can be performed synchronously, which improves the speed of the feature map processing without performance reduction.

In some embodiments, the determining a position of an anchor of at least one second convolutional kernel in the feature map at the next moment, according to a position that the anchor of the first convolutional kernel has already passed, comprises: determining the position of the anchor of the at least one second convolutional kernel in the feature map at the next moment, according to the position that the anchor of the first convolutional kernel has already passed and a position that the anchor of the second convolutional kernel has already passed.

For example, in addition to considering the point that has already been updated by using the first convolutional kernel, a point that has already been updated by using the second convolutional kernel is also considered. According to all the already updated points, a position of the anchor of the second convolutional kernel at the next moment is determined (i.e., a point that can be updated simultaneously with the reference point at the next moment).

In some embodiments, the determining the position of the anchor of the at least one second convolutional kernel in the feature map at the next moment, according to the position that the anchor of the first convolutional kernel has already passed and a position that the anchor of the second convolutional kernel has already passed, comprises: determining, according to the position that the anchor of the first convolutional kernel has already passed and the position that the anchor of the second convolutional kernel has already passed, at least one pair of feature points which are a first feature point located in an opposite direction of a first direction of the position of the anchor of the second convolutional kernel in the feature map at the next moment and a second feature point located in an opposite direction of a second direction thereof, wherein the first direction is a movement direction of the anchor of the first convolutional kernel in a row direction, and the second direction is a movement direction of the anchor of the first convolutional kernel in a column direction; and determining the position of the anchor of the second convolutional kernel in the feature map at the next moment according to the at least one pair of feature points.

For example, all already passed points (i.e., already updated points, including points that the anchors of the first and second convolutional kernels have already passed) in the feature map are first found out. Among the remaining points (i.e., to-be-updated points), to-be-updated points, on left and upper sides of which are already updated points, are found out, and the found to-be-updated point is taken as the position (additionally, from which it is needed to exclude a position which coincides with the position of the first convolutional kernel determined in the step S1) of the anchor of the second convolutional kernel at the next moment.

It is also possible to first determine a combination of the first feature point and the second feature point, where the first feature point and the second feature point are already updated points, and satisfy that a point on a right side of the first feature point and a point on a lower side of the second feature point are a same to-be-updated point.

In some embodiments, the determining the position of the anchor of the second convolutional kernel in the feature map at the next moment according to the at least one pair of feature points, comprises: for each pair of feature points in the at least one pair of feature points, determining a position of an anchor of one second convolutional kernel in the feature map at the next moment, according to a position located in the first direction of the first feature point and in the second direction of the second feature point.

For example, for each combination of the first feature point and the second feature point that satisfies the above condition, it may be determined that a position of the to-be-updated point (i.e., the point on the lower side of the second feature point) on the right side of the first feature point is the position of the anchor of the second convolutional kernel at the next moment.

In some embodiments, the position that the anchor of the first convolutional kernel has already passed comprises the position of the anchor of the first convolutional kernel in the feature map at the current moment, and the determining a position of an anchor of at least one second convolutional kernel in the feature map at the next moment, according to a position that the anchor of the first convolutional kernel has already passed, comprises: determining one or more values of an offset parameter according to the position of the anchor of the first convolutional kernel in the feature map at the current moment, wherein each of the values of the offset parameter corresponds to one second convolutional kernel; for the value of each offset parameter, determining a row: position of an anchor of the corresponding second convolutional kernel in the feature map at the next moment, according to the value of the offset parameter and a row index of the position of the anchor of the first convolutional kernel in the feature map at the current moment; and for the value of each offset parameter, determining a column index of the position of the anchor of the corresponding second convolutional kernel in the feature map at the next moment, according to the value of the offset parameter and a column index of the position of the anchor of the first convolutional kernel in the feature map at the current moment.

For example, since the movement of the anchor of the first convolutional kernel is regular, the current position of the anchor of the first convolutional kernel can directly reflect all the positions that the anchor of the first convolutional kernel has already passed. In addition, since at each moment, the position of the anchor of the second convolutional kernel is determined according to the anchor of the first convolutional kernel, the current position of the anchor of the first convolutional kernel can also directly reflect the position that the anchor of the second convolutional kernel has already passed. Therefore, it is possible to calculate the position that the anchor of the second convolutional kernel has already passed at the next moment directly according to the current position of the anchor of the first convolutional kernel.

In the present disclosure, according to the current position of the anchor of the first convolutional kernel, a feature point satisfying that feature values on the upper and left sides of the convolutional kernel region have already been updated (where the to-be-updated feature point is located at a central position of the convolutional kernel, i.e., the anchor) is determined, and therefore the position of the second convolutional kernel can be determined. It is able to calculate different positions which can be updated in parallel at the next moment directly according to the row index and column index of the anchor of the first convolutional kernel at the current moment, with low calculation complexity, thereby improving the convolution efficiency.

In addition, when the offset parameter n has more than one value, positions of anchors of a plurality of second convolutional kernels at the next moment can be obtained, and at the next moment, convolution can be performed simultaneously on the first convolutional kernel and the plurality of second convolutional kernels, further improving the convolution speed.

In some embodiments, the determining one or more values of the offset parameter according to the position of the anchor of the first convolutional kernel in the feature map at the current moment, comprises: generating a plurality of candidate values of the offset parameter, wherein the plurality of candidate values are an arithmetic progression; for each candidate value, determining whether the candidate value, the padding parameter and the column index of the position of the anchor of the first convolutional kernel in the feature map at the current moment satisfy a preset inequality; and determining the one or more values of the offset parameter according to a candidate value that satisfies the preset inequality.

For example, to calculate the position that the anchor of the second convolutional kernel has already passed at the next moment according to the current position of the anchor of the first convolutional kernel, the offset parameter n needs to be calculated. Starting from n=1, it is determined whether the value of n satisfies the following preset inequality:

$$i + n < H$$

$$j + 1 < W$$

$$j - ( p + 1 ) * n + 1 \geq 0$$

where H is a height of a feature map tensor, W is a width of the feature map tensor, i is the row index of the current position of the first convolutional kernel, and j is the column index of the current position of the first convolutional kernel.

It is determined whether n satisfies the above inequality, a value of n satisfying the condition is determined as one offset parameter, and then let the value of n be added with 1, determining whether n (=2, 3, 4, 5 . . . ) satisfies the above inequality is continued, until the inequality is not satisfied. Positions where arrows in FIG. 4 are located all are positions that anchors of second convolutional kernels have already passed, and it can be seen that, from the same position (one circle) of the anchor of the first convolutional kernel, positions (arrows) of anchors of a plurality of second convolutional kernels at the next moment can be extended.

By using the arithmetic progression as the candidate values of the offset parameter, all possible values of the offset parameter are fully considered, enabling convolution on all positions satisfying the condition to be performed simultaneously, further improving the speed of the convolution.

In some embodiments, the column index of the position of the anchor of the second convolutional kernel in the feature map at the next moment is in negative correlation with the padding parameter of the convolution.

In some embodiments, the row index of the position of the anchor of the second convolutional kernel in the feature map at the next moment is in positive correlation with the offset parameter and in positive correlation with the row index of the position of the anchor of the first convolutional kernel in the feature map at the current moment.

In some embodiments, the column index of the position of the anchor of the second convolutional kernel in the feature map at the next moment is in negative correlation with the offset parameter and in positive correlation with the column index of the position of the anchor of the first convolutional kernel in the feature map at the current moment.

After all the values of n are determined, they are substituted into X₂ (i+n, j−(p+1)*n+1), and all obtained X₂ are taken as positions of second convolutional kernels at the next moment.

In some embodiments, the determining the value of the offset parameter according to a candidate value that satisfies the preset inequality, comprises: when the first convolutional kernel reaches an edge of the feature map in the first direction at the current moment, determining the one or more values of the offset parameter according to a candidate value that satisfies the preset inequality and is not 1, wherein the first direction is a movement direction of the anchor of the first convolutional kernel in the row direction.

For example, when the first convolutional kernel reaches the edge of the feature map in the first direction, i.e., when flag=1, at this moment, a position of the anchor of the first convolutional kernel at the next moment is X₁ (i+1, j−p). However, at this moment, if n=1, there is also X₂ (i+1, j−p), resulting in coincidence of the positions of the first and second convolutional kernels at the next moment, and in order to make no coincidence of the positions of the first and second convolutional kernels at the next moment, the value of n=1 is excluded.

In some embodiments, the position of the anchor of the first convolutional kernel in the feature map at the next moment is not in the same row as the position of the anchor of each second convolutional kernel in the feature map at the next moment.

For example, at the next moment, the anchor of the first convolutional kernel are not in the same row as the anchor of the second convolutional kernel, and thus it is possible to simultaneously perform, in different rows of the feature map, convolution on the first and second convolutional kernels, which improves convolution efficiency, and reduce time complexity of the convolution.

In step S3, perform convolution on the feature map region corresponding to the first convolutional kernel by the first convolutional kernel and perform convolution on the feature map region corresponding to the at least one second convolutional kernel by the at least one second convolutional kernel simultaneously, at the next moment.

In some embodiments, the performing convolution on the feature map region corresponding to the first convolutional kernel by the first convolutional kernel and performing convolution on the feature map region corresponding to the at least one second convolutional kernel by the at least one second convolutional kernel simultaneously, at the next moment, comprises: determining the feature map region corresponding to the first convolutional kernel according to the position of the anchor of the first convolutional kernel in the feature map at the next moment; and determining the feature map region corresponding to the second convolutional kernel according to the position of the anchor of the second convolutional kernel in the feature map at the next moment.

For example, according to the position of the anchor of the first convolutional kernel in the feature map at the next moment, a feature map region corresponding to a scanning region of the first convolutional kernel may be determined, and similarly, a feature map region corresponding to a scanning region of the second convolutional kernel may be determined. At the next moment, convolution is simultaneously performed on the feature map region corresponding to the scanning region of the first convolutional kernel and the feature map region corresponding to the scanning region of the second convolutional kernel.

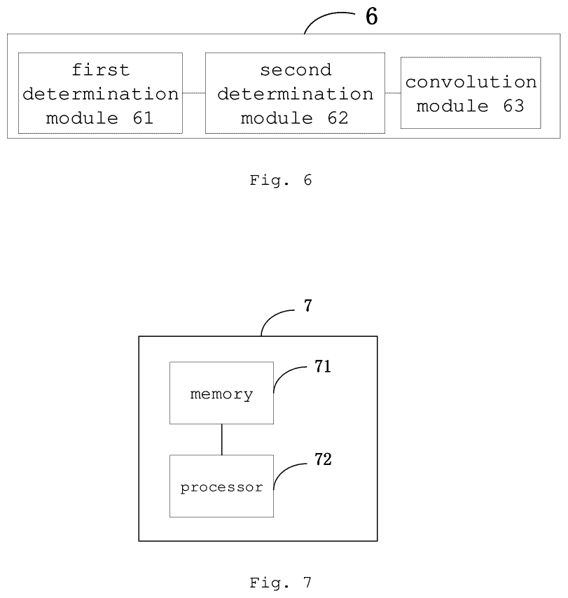

FIG. 5 illustrates a schematic diagram of a convolution sequence according to some embodiments of the present disclosure.

Numbers in FIG. 5 represent a time sequence. Five pictures in a first row represent a movement trajectory of a first convolutional kernel, and three pictures in a second row and one picture in a third row represent a movement trajectory of a second convolutional kernel. For example, at a time 3, convolution are simultaneously performed on a third position (excluding the padding edge) of the first row by using the first convolutional kernel and on a first position of the second row by using the second convolutional kernel, and at a time 5, convolution are simultaneously performed in parallel on a corresponding position of the first row by using the first convolutional kernel and on corresponding positions of the second and third rows by using the second convolutional kernel.

Compared with the serial context convolution method shown in FIG. 3, in the present disclosure, there is no need to wait for the completion of the convolution of the first row before the convolution of the second row, but the positions that satisfy the condition are found out in advance and convolution is performed in parallel, which requires shorter time.

According to the present disclosure, the position of the second convolutional kernel can be determined according to the position where convolution has already been performed using the first convolutional kernel, thereby simultaneously performing convolution for the first convolutional kernel and the second convolutional kernel, achieving parallel calculation of the convolution on the same feature map, and improving the speed of the feature map processing without performance reduction.

It is possible to apply, in any image processing that needs context convolution, the feature map processing method according to some embodiments of the present disclosure. For example, in a context convolution module in a cheng2020 deep learning end-to-end image coding model, the feature map processing method according to some embodiments of the present disclosure is used. Taking an example that an image 1920×1080×3 is input, a feature size entering the context model is 120×68×192, and a convolutional kernel size in the context model is 3×3.

An anchor (reference point) of the first convolutional kernel starts from (0,0), and according to the current position (0, 0) of the anchor of the first convolutional kernel, a feature point satisfying an updating condition is calculated as an anchor of the second convolutional kernel.

The anchor of the first convolutional kernel performs lateral movement updating before reaching a right edge, and when the anchor of the first convolutional kernel is at (0,2), the anchor of the first convolutional kernel is at (0,3) at a next moment, and the anchor of the second convolutional kernel is at (1, 0) at the next moment.

At the next moment, the anchor of the first convolutional kernel moves to (0, 3), and according to the anchor (0,3) of the first convolutional kernel, a feature point satisfying the updating condition is calculated, and it is obtained through the calculation that, the anchor of the first convolutional kernel at a next moment is at (0,4) and the anchor of the second convolutional kernel at the next moment is at (1,1).

At the next moment, the anchor of the first convolutional kernel moves to (0, 4), and according to (0,4), a feature point satisfying the updating condition is calculated, and it is obtained through the calculation that, the anchor of the first convolutional kernel at a next moment is at (0,5) and the anchor of the second convolutional kernel at the next moment is at (1,2).

At the next moment, the anchor of the first convolutional kernel moves to (0,5), and according to (0,5), a feature point satisfying the updating condition is calculated, and it is obtained through the calculation that, the anchor of the first convolutional kernel at a next moment is at (0,6) and anchors of two second convolutional kernels at the next moment are respectively at (1, 3) and (2,0), and so on.

Until the anchor of the first convolutional kernel moves to (0, 67), flag=1 is recorded. According to (0, 67), a feature point satisfying the updating condition is calculated, and it is obtained through the calculation that, the anchor of the first convolutional kernel at a next moment is at (1, 65) and anchors of second convolutional kernels at the next moment are respectively at (2, 62), (3, 59), (4, 56), (5, 53), (6, 50), (7, 47), (8, 44), (9, 41), (10, 38), (11, 35), (12, 32), (13, 29), (14, 26), (15, 23), (16, 20), (17, 17), (18, 14), (19, 11), (20, 8), (21, 5) and (22, 2).

At the next moment, the updating for the first row has been wholly completed, and the anchor of the first convolutional kernel moves to (1, 65).

FIG. 6 illustrates a block diagram of a feature map processing apparatus according to some embodiments of the present disclosure.

As shown in FIG. 6, the feature map processing apparatus 6 comprises a first determination module 61, a second determination module 62, and a convolution module 63.

The first determination module 61 is configured to determine a position of an anchor of a first convolutional kernel in a feature map at a next moment, according to a position of the anchor of the first convolutional kernel in the feature map at a current moment, for example, perform the step S1 shown in FIG. 6.

The second determination module 62 is configured to determine a position of an anchor of at least one second convolutional kernel in the feature map at the next moment, according to a position that the anchor of the first convolutional kernel has already passed, for example, perform the step S2 shown in FIG. 6.

The convolution module 63 is configured to, perform convolution on the feature map region corresponding to the first convolutional kernel by the first convolutional kernel and perform convolution on the feature map region corresponding to the at least one second convolutional kernel by the at least one second convolutional kernel simultaneously, at the next moment. For example, perform the step S3 shown in FIG. 6.

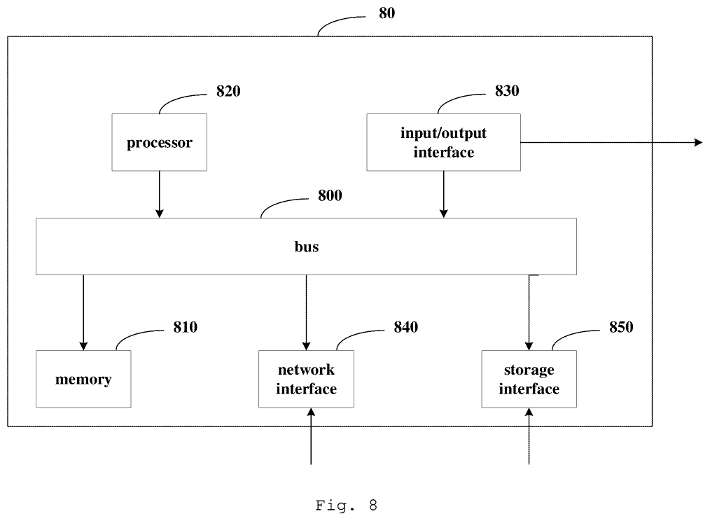

FIG. 7 illustrates a block diagram of a feature map processing apparatus according to other embodiments of the present disclosure.

As shown in FIG. 7, the feature map processing apparatus 7 comprises a memory 71; and a processor 72 coupled to the memory 71, the memory 71 being configured to store instructions for performing the feature map processing method. The processor 72 is configured to perform, based on the instructions stored in the memory 71, the feature map processing method in any of some embodiments of the present disclosure.

FIG. 8 illustrates a block diagram of a computer system for implementing some embodiments of the present disclosure.

As shown in FIG. 8, the computer system 80 may be represented in a form of a general-purpose computing device. The computer system 80 comprises a memory 810, a processor 820, and a bus 800 for connecting different system components.

The memory 810 may include, for example, a system memory, non-volatile storage medium, and the like. The system memory has, for example, an operating system, an application, a boot loader, and other programs stored thereon. The system memory may include a volatile storage medium, such as a random access memory (RAM) and/or cache memory. The non-volatile storage medium has, for example, instructions for performing the feature map processing method in any of some embodiments of the present disclosure stored thereon. The non-volatile storage medium includes, but is not limited to, a magnetic disk memory, optical memory, flash memory, and the like.

The processor 820 may be implemented using a general-purpose processor, a digital signal processor (DSP), an circuit (ASIC), a field application specific integrated programmable gate array (FPGA) or other programmable logic device, discrete gate or transistor and discrete hardware other components. Accordingly, each module such as the judgment module and the determination module may be implemented by a central processing unit (CPU) executing the instructions in the memory that performs the corresponding steps, or may be implemented by a dedicated circuit that performs the corresponding steps.

For the bus 800, any of a variety of bus structures may be used. For example, the bus structure includes, but is not limited to, an industry standard architecture (ISA) bus, micro channel architecture (MCA) bus, and peripheral component interconnect (PCI) bus.

The computer system 80 may also include an input/output interface 830, a network interface 840, a storage interface 850, and the like. These interfaces 830, 840, 850 as well as the memory 810 may be connected with the processor 820 via the bus 800. The input/output interface 830 may provide a connection interface for input/output devices such as a display, a mouse, and a keyboard. The network interface 840 provides a connection interface for a variety of networking devices. The storage interface 850 provides a connection interface for external storage devices such as a floppy disk, a USB flash disk, and an SD card.

Various aspects of the present disclosure are described herein with reference to the flow diagrams and/or block diagrams of the method, apparatus and computer program product according to the embodiments of the present disclosure. It should be understood that each block of the flow diagrams and/or block diagrams and a combination of the blocks can be implemented by computer-readable program instructions.

These computer-readable program instructions may be provided to a processor of a general-purpose computer, special-purpose computer, or other programmable apparatuses to produce a machine, such that execution of the instructions by the processor creates a means for implementing the functions specified in one or more blocks in the flow diagrams and/or block diagrams.

These computer-readable program instructions may also be stored in a computer-readable memory, and these instructions enable a computer to work in a specific manner, such that an article of manufacture is produced, including instructions for implementing the functions specified in one or more blocks in the flow diagrams and/or block diagrams.

The present disclosure may take the form of an entire hardware embodiment, an entire software embodiment, or an embodiment combining software and hardware aspects.

With the feature map processing method and apparatus and the computer-readable storage medium in the above embodiments, the speed of the feature map processing is improved.

So far, the feature map processing method and apparatus and the computer-readable storage medium according to the present disclosure have been described in detail. Some details well known in the art have not been described in order to avoid obscuring the concepts of the present disclosure. Those skilled in the art can fully appreciate how to implement the technical solutions disclosed herein according to the foregoing description.

1. A feature map processing method, comprising:
determining a position of an anchor of a first convolutional kernel in a feature map at a next moment, according to a position of the anchor of the first convolutional kernel in the feature map at a current moment;
determining a position of an anchor of each of at least one second convolutional kernel in the feature map at the next moment, according to a position that the anchor of the first convolutional kernel has already passed; and
performing convolution on the feature map region corresponding to the first convolutional kernel by the first convolutional kernel and performing convolution on the feature map region corresponding to the at least one second convolutional kernel by the at least one second convolutional kernel simultaneously, at the next moment.

2. The feature map processing method according to claim 1, wherein the determining a position of an anchor of each of at least one second convolutional kernel in the feature map at the next moment, according to a position that the anchor of the first convolutional kernel has already passed comprises:
determining the position of the anchor of the each of the at least one second convolutional kernel in the feature map at the next moment, according to the position that the anchor of the first convolutional kernel has already passed and a position that the anchor of the each of the second convolutional kernel has already passed.

3. The feature map processing method according to claim 2, wherein the determining the position of the anchor of the at least one second convolutional kernel in the feature map at the next moment, according to the position that the anchor of the first convolutional kernel has already passed and a position that the anchor of the second convolutional kernel has already passed comprises:
determining, according to the position that the anchor of the first convolutional kernel has already passed and the position that the anchor of the each of the at least one second convolutional kernel has already passed, at least one pair of feature points which comprises a first feature point and a second feature point, wherein the first feature point is located in an opposite direction of a first direction of the position of the anchor of the each of the at least one second convolutional kernel in the feature map at the next moment and a the second feature point is located in an opposite direction of a second direction thereof, the first direction is a movement direction of the anchor of the first convolutional kernel in a row direction, and the second direction is a movement direction of the anchor of the first convolutional kernel in a column direction; and
determining the position of the anchor of the each of the at least one second convolutional kernel in the feature map at the next moment according to the at least one pair of feature points.

4. The feature map processing method according to claim 3, wherein the determining the position of the anchor of the second convolutional kernel in the feature map at the next moment according to the at least one pair of feature points comprises:
for each pair of feature points among the at least one pair of feature points, determining the position of the anchor of the each of the at least one second convolutional kernel in the feature map at the next moment, according to a position located in the first direction of the first feature point and in the second direction of the second feature point.

5. The feature map processing method according to claim 3, wherein the determining a position of an anchor of a first convolutional kernel in a feature map at a next moment, according to a position of the anchor of the first convolutional kernel in the feature map at a current moment comprises:
in response that the first convolutional kernel does not reach an edge of the feature map in the first direction at the current moment, determining the position of the anchor of the first convolutional kernel in the feature map at the next moment, according to a position of the anchor of the first convolutional kernel after moving by a first stride in the first direction.

6. The feature map processing method according to claim 3, wherein the determining a position of an anchor of a first convolutional kernel in a feature map at a next moment, according to a position of the anchor of the first convolutional kernel in the feature map at a current moment comprises:
in response that the first convolutional kernel reaches an edge of the feature map in the first direction at the current moment, determining the position of the anchor of the first convolutional kernel in the feature map at the next moment, according to the position of the anchor of the first convolutional kernel in the feature map at the current moment and a padding parameter of convolution.

7. The feature map processing method according to claim 6, wherein the in response that the first convolutional kernel reaches an edge of the feature map in the first direction at the current moment, determining the position of the anchor of the first convolutional kernel in the feature map at the next moment, according to the position of the anchor of the first convolutional kernel in the feature map at the current moment and a padding parameter of the convolution comprises:
determining the position of the anchor of the first convolutional kernel in the feature map at the next moment, according to a position that the anchor of the first convolutional kernel reaches after moving by a second stride in the second direction and moving by a same length as the padding parameter in the opposite direction of the first direction, from the position in the feature map at the current moment.

8. The feature map processing method according to claim 1, wherein the position that the anchor of the first convolutional kernel has already passed comprises the position of the anchor of the first convolutional kernel in the feature map at the current moment, and the determining a position of an anchor of at least one second convolutional kernel in the feature map at the next moment, according to a position that the anchor of the first convolutional kernel has already passed comprises:
determining one or more values of an offset parameter according to the position of the anchor of the first convolutional kernel in the feature map at the current moment, wherein each of the values of the offset parameter corresponds to one second convolutional kernel;
for each of the one or more values of the offset parameter, determining a row index of a position of an anchor of the second convolutional kernel corresponding to the value of the offset parameter in the feature map at the next moment, according to the value of the offset parameter and a row index of the position of the anchor of the first convolutional kernel in the feature map at the current moment; and
for each of the one or more values of the offset parameter, determining a column index of the position of the anchor of the second convolutional kernel corresponding to the value of the offset parameter in the feature map at the next moment, according to the value of the offset parameter and a column index of the position of the anchor of the first convolutional kernel in the feature map at the current moment.

9. The feature map processing method according to claim 8, wherein the determining one or more values of an offset parameter according to the position of the anchor of the first convolutional kernel in the feature map at the current moment comprises:
generating a plurality of candidate values of the offset parameter, wherein the plurality of candidate values are an arithmetic progression;
for each candidate value of the candidate values, determining whether the candidate value, the padding parameter and the column index of the position of the anchor of the first convolutional kernel in the feature map at the current moment satisfy a preset inequality; and
determining the one or more values of the offset parameter according to one or more candidate values that satisfy the preset inequality.

10. The feature map processing method according to claim 9, wherein the determining the value of the offset parameter according to a candidate value that satisfies the preset inequality comprises:
in response that the first convolutional kernel reaches an edge of the feature map in the first direction at the current moment, determining the one or more values of the offset parameter according to a candidate value that satisfies the preset inequality and is not 1, wherein the first direction is a movement direction of the anchor of the first convolutional kernel in the row direction.

11. The feature map processing method according to claim 8, wherein the column index of the position of the anchor of the each of the at least one second convolutional kernel in the feature map at the next moment is in negative correlation with the padding parameter of the convolution.

12. The feature map processing method according to claim 8, wherein the row index of the position of the anchor of the each of the at least one second convolutional kernel in the feature map at the next moment is in positive correlation with the offset parameter and in positive correlation with the row index of the position of the anchor of the first convolutional kernel in the feature map at the current moment.

13. The feature map processing method according to claim 8, wherein the column index of the position of the anchor of the second convolutional kernel in the feature map at the next moment is in negative correlation with the offset parameter and in positive correlation with the column index of the position of the anchor of the first convolutional kernel in the feature map at the current moment.

14. The feature map processing method according to claim 6, wherein the padding parameter of the convolution is in positive correlation with a size of the first convolutional kernel.

15. The feature map processing method according to claim 1, wherein the performing convolution on the feature map region corresponding to the first convolutional kernel by the first convolutional kernel and performing convolution on the feature map region corresponding to the at least one second convolutional kernel by the at least one second convolutional kernel simultaneously, at the next moment comprises:
determining the feature map region corresponding to the first convolutional kernel according to the position of the anchor of the first convolutional kernel in the feature map at the next moment; and
determining the feature map region corresponding to the each of the at least one second convolutional kernel according to the position of the anchor of the each of the at least one second convolutional kernel in the feature map at the next moment.

16. The feature map processing method according to claim 1, wherein the position of the anchor of the first convolutional kernel in the feature map at the next moment and the position of the anchor of the each of the at least one second convolutional kernel in the feature map at the next moment are in different rows.

17. (canceled)

18. A communication device, comprising:
a memory; and
a processor coupled to the memory, the processor being configured to perform, based on instructions stored in the memory, a feature map processing method, comprising:
determining a position of an anchor of a first convolutional kernel in a feature map at a next moment, according to a position of the anchor of the first convolutional kernel in the feature map at a current moment;
determining a position of an anchor of each of at least one second convolutional kernel in the feature map at the next moment, according to a position that the anchor of the first convolutional kernel has already passed; and
performing convolution on the feature map region corresponding to the first convolutional kernel by the first convolutional kernel and performing convolution on the feature map region corresponding to the at least one second convolutional kernel by the at least one second convolutional kernel simultaneously, at the next moment.

19. A non-transitory computer-readable storage medium having thereon stored computer program instructions which, when executed by a processor, implement a feature map processing method, comprising:
determining a position of an anchor of a first convolutional kernel in a feature map at a next moment, according to a position of the anchor of the first convolutional kernel in the feature map at a current moment;
determining a position of an anchor of each of at least one second convolutional kernel in the feature map at the next moment, according to a position that the anchor of the first convolutional kernel has already passed; and
performing convolution on the feature map region corresponding to the first convolutional kernel by the first convolutional kernel and performing convolution on the feature map region corresponding to the at least one second convolutional kernel by the at least one second convolutional kernel simultaneously, at the next moment.

20. (canceled)

21. The communication device according to claim 18, wherein the determining a position of an anchor of each of at least one second convolutional kernel in the feature map at the next moment, according to a position that the anchor of the first convolutional kernel has already passed comprises:
determining the position of the anchor of the each of the at least one second convolutional kernel in the feature map at the next moment, according to the position that the anchor of the first convolutional kernel has already passed and a position that the anchor of the each of the second convolutional kernel has already passed.

22. The non-transitory computer-readable storage medium according to claim 19, wherein the determining a position of an anchor of each of at least one second convolutional kernel in the feature map at the next moment, according to a position that the anchor of the first convolutional kernel has already passed comprises:
determining the position of the anchor of the each of the at least one second convolutional kernel in the feature map at the next moment, according to the position that the anchor of the first convolutional kernel has already passed and a position that the anchor of the each of the second convolutional kernel has already passed.
